(19) United States
(12) Patent Application Publication
(10) Pub. No.: US 2006/0219749 A1
(43) Pub. Date: Oct. 5, 2006

(54) Safety control pin for controlling a push plate to activate pneumatic switch of pneumatic staplers

(76) Inventor: Wen-Sheng Huang, Ta Li City (TW)

Correspondence Address: PHILLIP LIU, 6980, WHITEOAK DR., RICHMOND, BC, V7EAZ9, CA

(21) Appl. No.: 11/091,473

(22) Filed: Mar. 29, 2005

(51) Int. Cl. B25C 1/04

(52) U.S. Cl. 227/8; 227/130

(57) ABSTRACT

A safety device for pneumatic staplers includes a control pin movably connected to the barrel of the stapler and the control pin has a first groove and a second groove, wherein the first groove has a depth deeper than that of the second groove. A trigger pivotably connected to the barrel has two sidewalls and each side wall has a protrusion which is engaged with one of the first and second grooves. A push plate has a first end pivotably connected between the two sidewalls of the trigger and a second end of the push plate has a tongue extending axially therefrom. The push plate is located beside a pneumatic switch of the stapler. A safety link is movably connected to the barrel and an end of the safety link is located corresponding to the tongue of the push plate. If the trigger is pulled before the safety link is pushed against an object, the tongue is not pushed and co-moved with the safety link so that the pneumatic switch will not be activated.

### FIELD OF THE INVENTION

The present invention relates to a safety device that includes a control pin with two grooves of different depths so as to respectively cooperate with the safety links for proceed single or continuous shooting.

### BACKGROUND OF THE INVENTION

Some conventional pneumatic mailers or staplers include functions of single-shoot and continuous-shoot, wherein a switch member is connected to the trigger so that the user may operate the switch member to set the stapler in single-shoot or continuous-shoot status. In order to reduce protrusions form the trigger, the switch member is usually made to be in flush with two sides of the trigger. However, this is difficult for the user to operate the switch member. Besides, the switch member is connected with a spring, an eccentric rod and a press board. All of the parts are installed in a small space and that will be a time-consuming task for the assemblers. Furthermore, the switch member is operated independently from the safety link of the pneumatic staplers so that that are potential problems to be overcome and improved.

The present invention intends to provide a control pin movably connected to the barrel and located above the trigger, and the control pin includes two grooves of different depths so as to respectively cooperate with the trigger and the push plate in the trigger. The push plate activates the pneumatic switch only when the safety links is properly pushed against the object.

### SUMMARY OF THE INVENTION

The present invention relates to a safety device for pneumatic staplers and comprises a control pin movably connected to the barrel of the stapler and a first groove and a second groove are defined in an outer periphery of the control pin. The first groove has a depth deeper than that of the second groove. A trigger is pivotably connected to the barrel and has two sidewalls, each side wall has a protrusion which is engaged with one of the first and second grooves. A push plate has a first end pivotably connected between the two sidewalls of the trigger and a second end of the push plate is a free end. The push plate is located beside a pneumatic switch of the stapler. A safety link is movably connected to the barrel and an end of the safety link is located corresponding to the second end of the push plate.

The length of the push plate is sized such that the second end of the push plate is pushed to activate the pneumatic switch only if the safety link is pushed against an object before the trigger is pulled.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the safety device and the pneumatic stapler of the present invention;

FIG. 2 shows that the protrusion of the trigger is engaged with the shallow groove in the control pin and the pneumatic switch cannot be activated if the safety link is not pushed first;

FIG. 3 shows that the second end of the push plate is pushed by the safety link;

FIG. 4 shows that the pneumatic switch is activated by the push plate when pulling the trigger;

FIG. 5 shows that after shooting, the second end of the push plate and the safety link slightly move away from the pneumatic switch, while the second end of the push plate is still engaged with the safety link;

FIG. 6 shows that the protrusion of the trigger is engaged with the deeper groove in the control pin and the pneumatic switch cannot be activated if the safety link is not pushed first;

FIG. 7 shows that the second end of the push plate is pushed by the safety link, and

FIG. 8 shows that the pneumatic switch is activated by the push plate when pulling the trigger.

### DETAILED DESCRIPTION OF THE PREFERRED EMBODIMENT

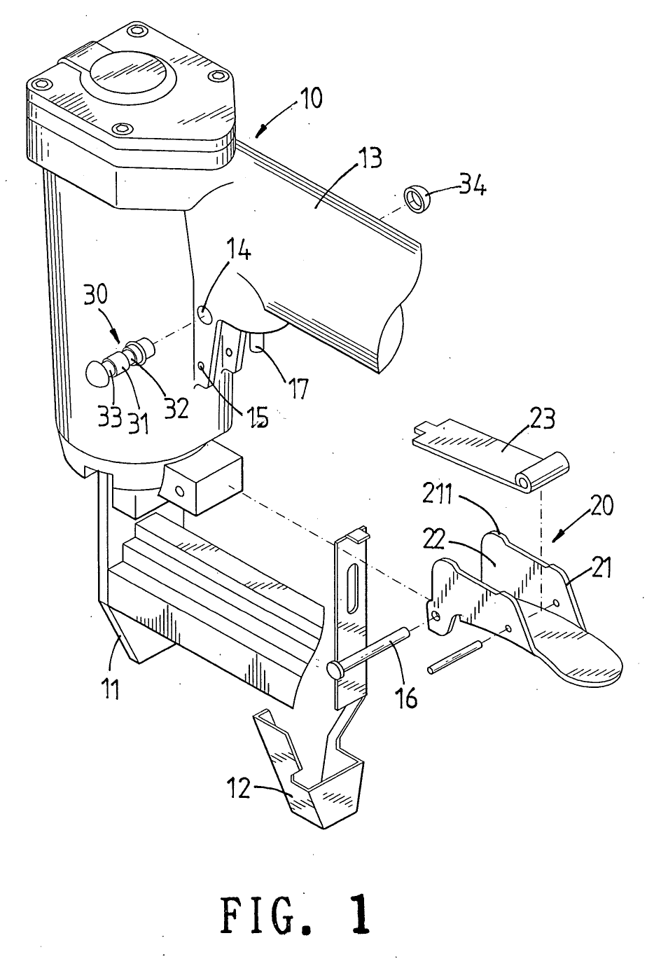

Referring to FIG. 1, the safety device of the present invention comprises a control pin 30 which is a tubular bar 31 and includes a first groove 32 and a second groove 33, wherein the first groove 32 has a depth deeper than that of the second groove 33. The control pin 30 movably extends through a hole 14 defined through a portion close to the handle 13 and two ends of the control pin 30 alternatively extend out from the barrel connected to the handle of the pneumatic stapler 10. Two end caps 34 are mounted to the two ends of the control pin 30 so that the user may push either one of the two end caps 34 to operate the control pin 30.

A trigger 20 is pivotably connected to the portion connected to the barrel and the handle by extending a pin 16 through two sidewalls 21 of the trigger 20 and a hole 15 defined through the portion. Each side wall 21 has a protrusion 211 which is engaged with one of the first and second grooves 32, 33. A push plate 23 has a first end pivotably connected in a space 22 between the two sidewalls 21 of the trigger 20 and a second end of the push plate 23 is a free end which has a tongue extending axially therefrom. The push plate 23 is located beside a pneumatic switch 17 of the stapler 10.

A safety link 12 is movably connected to the barrel and an end of the safety link 12 is located corresponding to the tongue of the push plate 23.

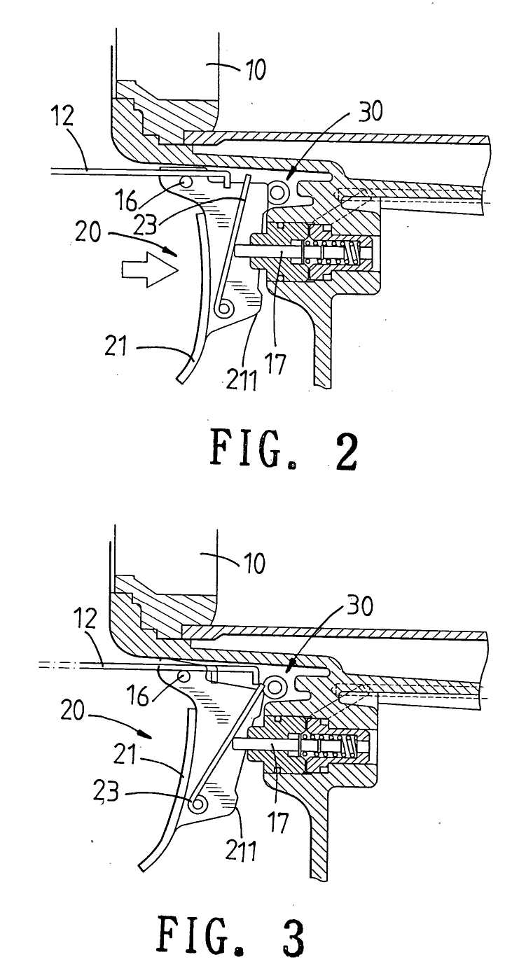

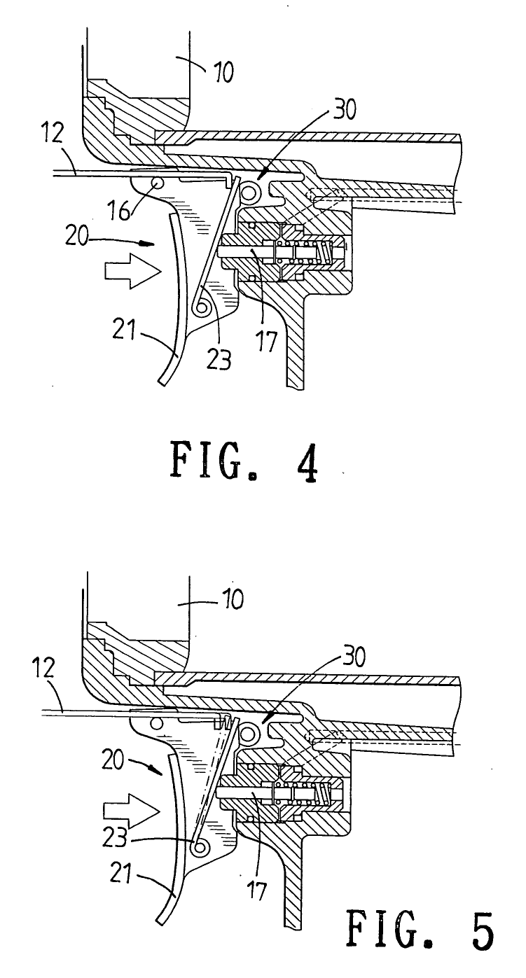

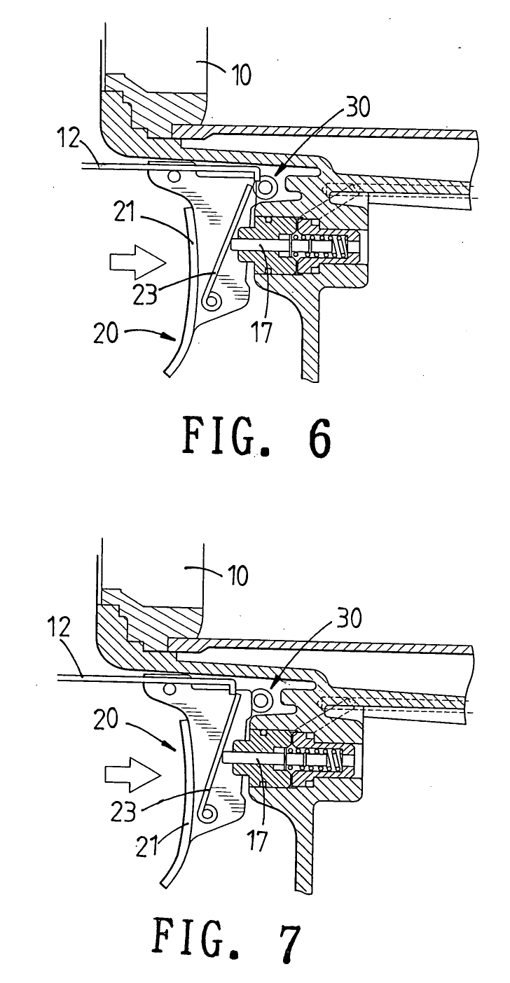

As shown in FIG. 2, if the user pulls the trigger 20 before the safety link 12 is pushed against an object to be stapled (not shown), the protrusion 211 is engaged with the shallow second groove 33 and stop by the control pin 30, so that the push plate 23 cannot moved further to activate the pneumatic switch 17. Therefore, the stapler cannot shoot. As shown in FIGS. 3 and 4, when the safety link 12 is first pushed against the object, the tongue on the second end of the push plate 23 is pushed by the end of the safety link 12, so that when pulling the trigger 20, the push plate 23 is moved with the movement of the trigger 20 so as to activate the pneumatic switch 17 to shoot a staple from the nose 11 at front end of the barrel. As shown in FIG. 5, the reaction force form the shooting moves the push plate 23 and the safety link 12 slightly away from the pneumatic switch 17, in the meanwhile, the tongue on the second end of the push plate 23 is still engaged with the end of the safety link 12, so that when the safety link 12 is pushed against the object again, and the trigger 20 is pulled, another staple is ejected from the nose 11.

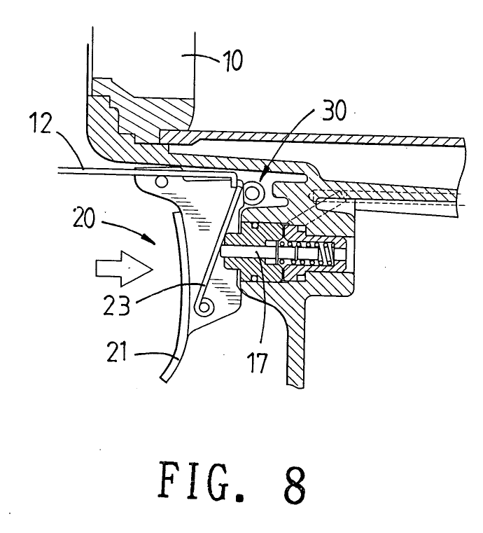

When pushing the control pin 30, and pulling the trigger 20 without pushing the safety link 12 against the object first, as shown in FIG. 6, because the depth of the first groove 32 is deeper than that of the second groove 33, the second end of the push plate 23 pivoted a large angle and is lowered. When the protrusion 211 is engaged with the first groove 32 and the trigger 20 is stopped by the control pin 30, the pneumatic switch 17 cannot be activated by the push plate 23. As shown in FIG. 7, if the safety link 12 is pushed against an object first, the tongue on the second end of the push plate 23 is engaged with the end of the safety link 12, so that when the trigger 20 is pulled, a staple is ejected from the nose 11 as shown in FIG. 8. After the staple is ejected, because of the deeper first groove 32, the push plate 23 is pivoted toward the pneumatic switch 17 a larger angle so that the tongue of the push plate 23 is disengaged from the safety link 12. Therefore, the user has to push the safety link against an object again and then pull the trigger 20 to shoot another staple. This allows the pneumatic stapler to be operated as a single-shoot stapler.

While we have shown and described the embodiment in accordance with the present invention, it should be clear to those skilled in the art that further embodiments may be made without departing from the scope of the present invention.

What is claimed is:

1. A safety device for pneumatic staplers, comprising:
a control pin being a tubular bar and adapted to be movably connected to the barrel of the stapler and having a first groove and a second groove, the first groove having a depth deeper than that of the second groove;
a trigger adapted to be pivotably connected to the barrel and having two sidewalls, each side wall having a protrusion which is engaged with one of the first and second grooves;
a push plate having a first end pivotably connected between the two sidewalls of the trigger and a second end of the push plate being a free end, the push plate adapted to be located beside a pneumatic switch of the stapler, and a safety link adapted to be movably connected to the barrel and an end of the safety link located corresponding to the second end of the push plate.

2. The device as claimed in claim 1, wherein a length of the push plate is sized that the safety link pushes the second end of the push plate only when the safety link is adapted to be pushed against an object before the trigger is pulled.

3. The device as claimed in claim 1, wherein two ends of the control pin are adapted to alternatively extend out from the barrel.

4. The device as claimed in claim 3, wherein two end caps are mounted to the two ends of the control pin.

5. The device as claimed in claim 1, wherein a tongue extends axially from the second end of the push plate.
